(19) United States
(12) Patent Application Publication
(10) Pub. No.: US 2006/0198692 A1
(43) Pub. Date: Sep. 7, 2006

(54) Fingertip dispenser, typically for a cosmetic product

(76) Inventor: Robert Petit, Cluny (FR)

Correspondence Address: YOUNG & THOMPSON, 745 SOUTH 23RD STREET, 2ND FLOOR, ARLINGTON, VA, 22202, US

(21) Appl. No.: 11/072,232

(22) Filed: Mar. 7, 2005

(51) Int. Cl. B65D 35/22; B05C 11/00; B43K 1/06; B43M 11/06; B43K 23/12

(52) U.S. Cl. 401/266; 222/94; 401/265; 401/263; 401/262

(57) ABSTRACT

A product dispenser includes: a) a tubular body containing the product and a skirt open at its lower portion and closed at its upper portion by an arch equipped with at least one opening, b) a piston capable of sliding, in a leak-proof manner, inside the skirt, so as to compress the product, and force the passage of the product through the opening, and c) a cap designed to seal the opening, cooperating reversibly with the tubular body at its upper part or with said arch.

### FIELD OF THE INVENTION

This invention relates to the field of dispensers for cosmetic products, and typically for cosmetic products of a paste-like consistency.

### PRIOR ART

Cosmetic products are packaged in packagings that are selected according to the nature of the cosmetic product, thus, for example:
very fluid products, typically liquids, are often packaged, in aerosol spray cans or in containers equipped with a dispensing pump,
products of a paste-like consistency, for example lipstick products, are packaged in lipstick tubes that constitute both a packaging and an applicator, in as much as the user moves the tube itself in order to apply to their lips the upper end of the rouge contained inside the tube,
products of a solid consistency, for example blocks of makeup powder, are typically packaged in compacts, a puff serving as an applicator included with each compact.

Problems Posed

On the one hand, as is apparent with the cosmetic products and their applicators according to the prior art, to a given cosmetic product corresponds a specific method of packaging. One object of the present invention is to furnish a cosmetic product dispenser suited to a wide range of different products.

On the other hand, in the case of the packaging of cosmetic products having a paste-like consistency, such as lipsticks, eye shadow or other products applied in a line, the user generally needs a range of shades for the same base product, so as to potentially coordinate the makeup colors with those of articles of clothing, or a series of means of application, depending on the degree of fineness of the line desired.

Furthermore, to impose a given applicator also gets back to imposing upon any user the same means of application, corresponding to the “average” requirements, whereas requirements and tastes may vary from one person to another. In particular, achieving a fine application, either very localized or with a fine line, is difficult if not impossible to do with conventional applicators.

Thus, another object of the present invention is to furnish cosmetic product dispensers that are sufficiently economical and sufficiently compact to be capable of being typically marketed either individually or in the form of a set of dispensers, so that, even with one handbag, neither the price or the overall dimensions are an obstacle to using several of these dispensers, differing by the shades of the cosmetic products and/or the nature or degree of fineness of the means of application.

Finally, in the field of cosmetic products, there is an on-going necessity to renew the product supply, i.e., to continuously offer brand new products and services or brand new functionalities.

The invention also aims to resolve other problems that will be introduced later.

### DESCRIPTION OF THE INVENTION

According to the invention, the dispenser of a product, typically a paste-like cosmetic product, comprises:

a) a tubular body containing said product and comprising a skirt open at its lower portion and closed at its upper portion by an arch equipped with an opening, or possibly with multiple openings, having a total surface area S′ enabling the passage of said product with a view to its use or application onto a support,

b) a piston capable of sliding, in a typically leak-proof manner, inside of said skirt, over a stroke height h, so as to form a variable-volume chamber containing said product and to compress said product with a view to forcing the passage of said product through said opening,

c) a cap designed to seal said opening, cooperating reversibly with said tubular body at its upper part or with said arch,

and is characterized in that said skirt has an interior horizontal section with a surface area S and with a smaller interior dimension d ranging typically from 10 mm to 20 mm, said stroke height h ranging typically from 10 to 25 mm, so as to simultaneously, and typically with a single hand, enable said dispenser to be grasped manually, typically between the thumb and middle finger, and said piston to be pushed manually using one finger, typically the index finger, so as to force, in a typically controlled manner, said passage of said product through said opening having a surface area S″<S, typically selected with respect to the nature of said product, said dispenser being an extension of said finger and thereby forming a so-called “fingertip” dispenser that is at once economical, compact and versatile.

By means of its interior section S and the piston stroke h, the dispenser according to the invention makes it possible to operate the piston with one finger, typically over its entire stroke, while at the same time ensuring that the dispenser is grasped manually with the fingers of the same hand, so as to have in one hand the dispenser and its exposed contents, the other hand being free, for example, to hold a mirror.

In the case of the dispenser according to the invention, it is important, therefore, that a finger, e.g., the index finger, be able to slip into the tubular body in order to push the piston as said product is being depleted.

The dispenser according to the invention makes it possible to solve the problems posed.

As a matter of fact, on the one hand, the dispenser according to the invention is not limited to the packaging of a specific product, but of an entire series of different products, the single common point among all of these products being their ability to flow through an opening, subject to the manual pressure exerted on the piston. The lesser the ability of the product to deform under stress, the larger the opening will be. A part from the not so deformable solid products and the liquid products having too low of a viscosity, which would pass through said opening by mere gravity alone, the majority of the other products, which corresponds to a wide range of different products, can be packaged in a dispenser according to the invention.

On the other hand, the dispensers according to the invention respond to the double concern for being compact, with regards to their dimensions, and relatively economical by reason of the small number of parts and their ease of assembly, with the result being that they make it possible to have at one's disposal, in a single handbag, as many dispensers as desired.

Lastly, the dispensers according to the invention also open the way for new objects that depart radically from conventional dispensers, and thereby contribute to meeting the on-going need for novelty, in particular as concerns the cosmetic product packaging market.

### DESCRIPTION OF THE FIGURES

All of the figures relate to the invention.

FIGS. 1a to 1d relate to an exemplary embodiment of a dispenser 1, closed in FIGS. 1a to 1d, and open in FIG. 1e.

FIG. 1a is an axial section of a dispenser 1 with a flat grate 200, cut along the vertical axis 10 A-A in FIG. 1b.

The piston 3, in its end of travel position, has been shown by a dotted line.

FIG. 1b is a side view of the dispenser 1.

FIG. 1c is a perspective view from the top and side of the dispenser 1.

FIG. 1d is a perspective view from underneath and to the side of the dispenser 1.

FIG. 1e is a perspective view of the open dispenser 1, the cap 4 having been separated from the body 2.

FIGS. 2a to 2d are top views of the arch 20 of the body 2 illustrating selected types of openings 22 and selected dispenser shapes (cross section):

multiple openings 222 forming a grate in FIG. 2a,

multiple openings 222 arranged radially in FIG. 2b,

multi-lobe opening formed by radial extensions 203 in FIG. 2c,

radial-slotted opening 221 in FIG. 2e,

circular center opening 220 in FIG. 2d.

FIG. 2f is a partial section in the vertical plane E-E of FIG. 2e, and D-D of FIG. 2d, showing lips 2200, 2210 surrounding said opening 220, 221 and potentially forming a means of application of said product 5.

FIGS. 3a and 3b are partial views in a vertical plane of a dispenser 1, showing two ways of rendering the cap 4 integral with the body 2:

FIG. 3a shows the cooperation between the cap 4 and the body 2 by means of a hinge 62 enabling the cap 4 to rotate in relation to the body 2, and a means of fastening 64 by cooperating male and female elements, the cap 4 including an arm that can be snapped on to a hinge pin of the body 2,

FIG. 3b shows the case where the cap 4, together with the body 2, forms a single piece, typically made of a molded plastic material, a flexible tab 63 joining together the two elements 2 and 4.

FIGS. 4a to 4c are partial views in a vertical plane of a dispenser 1, showing two other types of arches: FIG. 4a shows the case of a dispenser 1′ whose arch 20 forms a domed grate 201, while FIG. 4b shows the case of a dispenser 1″ whose arch 20 forms a dished grate 202. In the latter case, the cap 4 is equipped with a means of application 43 coming into contact with said dished grate 202, so as to be able to transfer said product onto said means of application 43.

FIG. 4c shows the case of a dispenser 1′″ for a solid product, with an opening having a surface area S′ slightly smaller than surface area S, said arch 20 then being limited to a circular rib 204. Said cap 4 includes a means of application 43, typically compressible or expansible, coming to rest against said product 5, shown in this figure (but not shown in FIGS. 1a, 4a, 4b and 5e).

FIGS. 5a to 5d show various types of “plane” dispenser sets 8.

FIG. 5a is a top view of a set of “plane” dispensers 8 including a support 80, 81, 82 for six dispensers 1, 1′, 1″, 1′″.

FIGS. 5b to 5e are partial sectional views in a vertical plane, showing three arrangements of a set 8 including as many positively connecting cavities 800, 810, 820 as dispensers 1, 1′, 1″, 1′″ to be brought together, or a set 8′ forming a variant of said set 8.

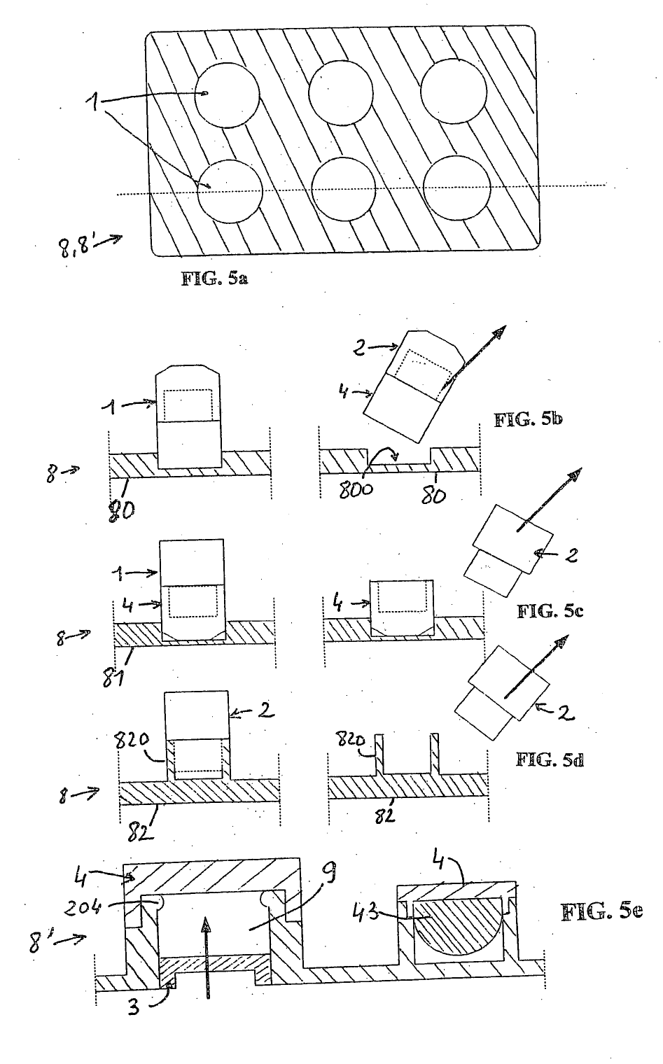

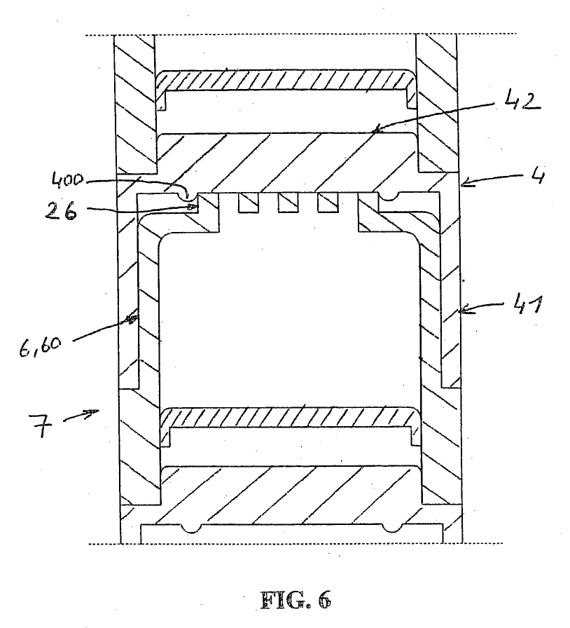

In FIGS. 5b to 5d, the dispenser, prior to being opened, is shown on the left side, and, on the right side, the portion of the dispenser that has been manually separated from the support 80, 81, 82.

In the case of FIG. 5b, the entire dispenser 1, 1′, 1″, 1′″ can be removed, which is temporarily assembled to the support 80 by means of cavities 800.

In the case of FIG. 5c, only the body 2 of the dispenser 1, 1′, 1″, 1′″ can be removed, its cap 4 having been fastened to the support 81 by an assembly means such as a friction-type connection or by gluing 810.

In the case of FIG. 5d, the support 82 includes as many cap-forming-walls 820 as dispensers 1, 1′, 1″, 1′″ to be made integral with one another.

FIG. 5e shows the case of a set 8′, which is a variant of the preceding set 8, in which, for illustrative purposes, the support 83 includes an open cavity 830 making it possible to slide a piston 3 and to connect a cap 4, so as to form a chamber 9 for said product 5, typically an agglomerated powder, and another type of cavity 831 with a bottom, capable of containing a means of application 43 mounted on a cap 4′.

FIG. 6 is a partial sectional view along the vertical axis, of a set of “vertical” dispensers 1, 1′, 1″, 1′″ rendered integral with each other in the form of a stick. To achieve this, the upper profile 42 of the cap of a given dispenser in enables it to cooperate with the lower part 21 of the “following” dispenser 1ₙ₊₁ situated “above it,” the lower portion of said given dispenser cooperating in like manner with the cap of the “preceding” dispenser 1ₙ₋₁ situated “beneath it.”

### DETAILED DESCRIPTION OF THE INVENTION

According to the invention, said skirt 21 of said body 2 may have a round, oval or square interior and/or exterior cross section, said interior cross section corresponding to that of the piston 3 and having a surface area S typically ranging from 50 mm² to 400 mm², and more preferably from 150 to 250 mm².

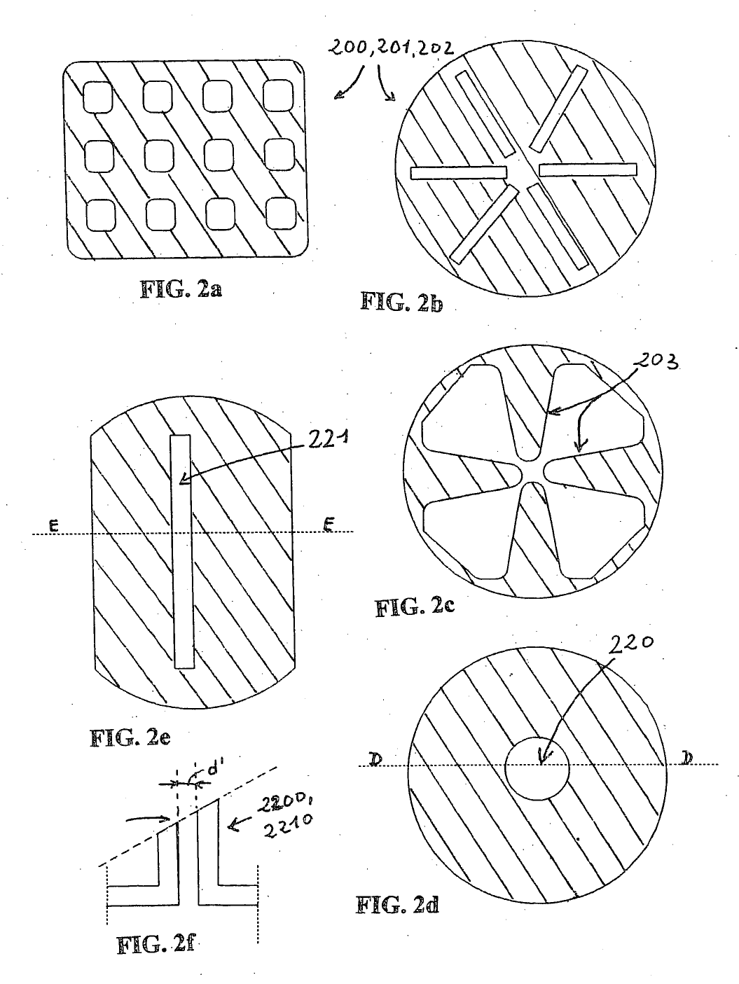

FIGS. 2a, 2b and 2e likewise show some examples of cross sections, the invention not being limited to a particular cross-sectional shape. Nevertheless, the shape and surface area S must be such that it is possible to manually push back said piston 3 to its end of travel position so as to be able to use up all of the product 5 contained inside the chamber 9 of the dispenser 1.

According to a first variant of the invention shown in FIG. 2c, said arch 20 may include or form at least one radial extension or projection 203 partially obstructing said surface area S, such that the surface area S′ of said opening 22, 222 typically ranges between 0.2.S and 0.8.S, said surface area being selected, in particular, with respect to the viscosity of said product, and so as to typically form multiple openings.

For illustrative purposes, four right-angled radial projections have been shown in FIG. 2c.

According to a second variant of the invention, illustrated in particular in FIGS. 2a and 2b, said arch 20 may include or form a grate, typically flat 200, but potentially domed 201, or dished 202, equipped with a large number of openings, said number typically ranging from 5 to 50, and having a total surface area S′<0.7.S for all of these openings combined.

According to a third variant of the invention shown in figure, 2e, said opening 22 may be a radial slot 221 having a length d′, typically close to d, and having a surface area S′<0.5.S, said radial slot 221 capable of forming potentially flexible lips, typically being parallel, and typically angled so as to form an applicator of said product over a width d′, as shown in FIG. 2f.

According to a fourth variant of the invention shown in FIG. 2d, said opening 22 may be a circular opening 220 having a diameter typically smaller than 5 mm, and a surface area S′<0.3.S, and capable of typically forming a circular lip 2200 so as to ensure a localized or spot application of said product 5, as shown in FIG. 2f.

According to the invention, said arch 20, equipped with said opening 22, 220, 221, 222 may form a means of application of said product 5. FIG. 2f shows this possibility thanks to typically flexible lips 220, 2210.

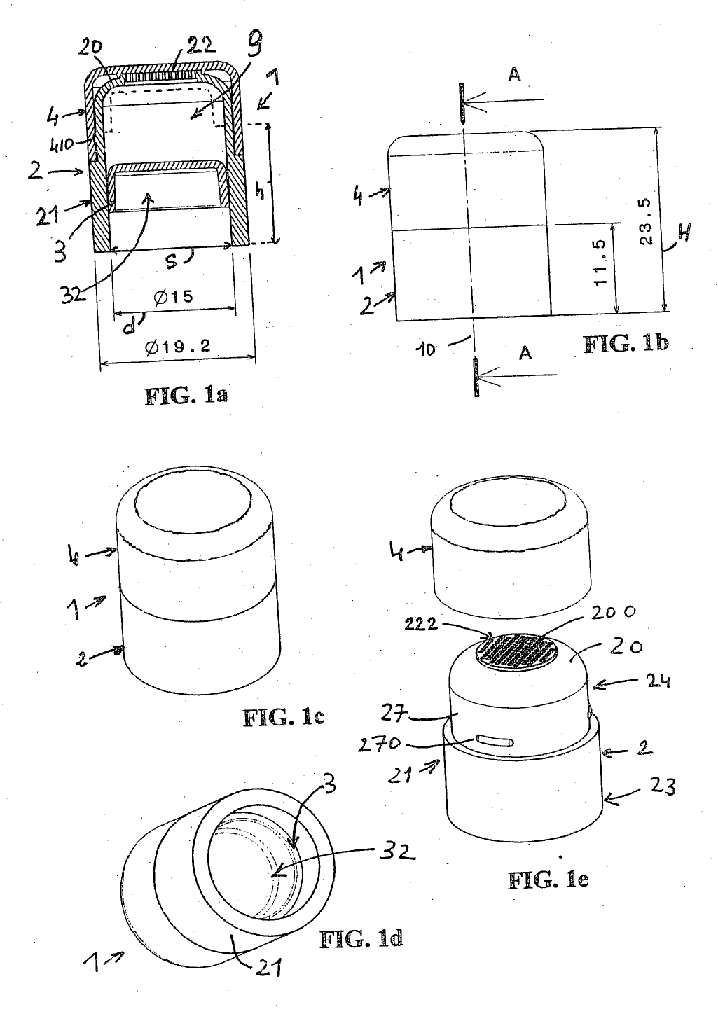

However, as shown in FIG. 1a, the portion of said arch 20 comprising said opening 22, 222 may form an axial projection forward from said arch 20, typically by a few mm, in particular so as to facilitate the application of said product 5 onto said support and to prevent it from spreading out over said dispenser, but also, as will be pointed out below, to seal said opening 22, 222.

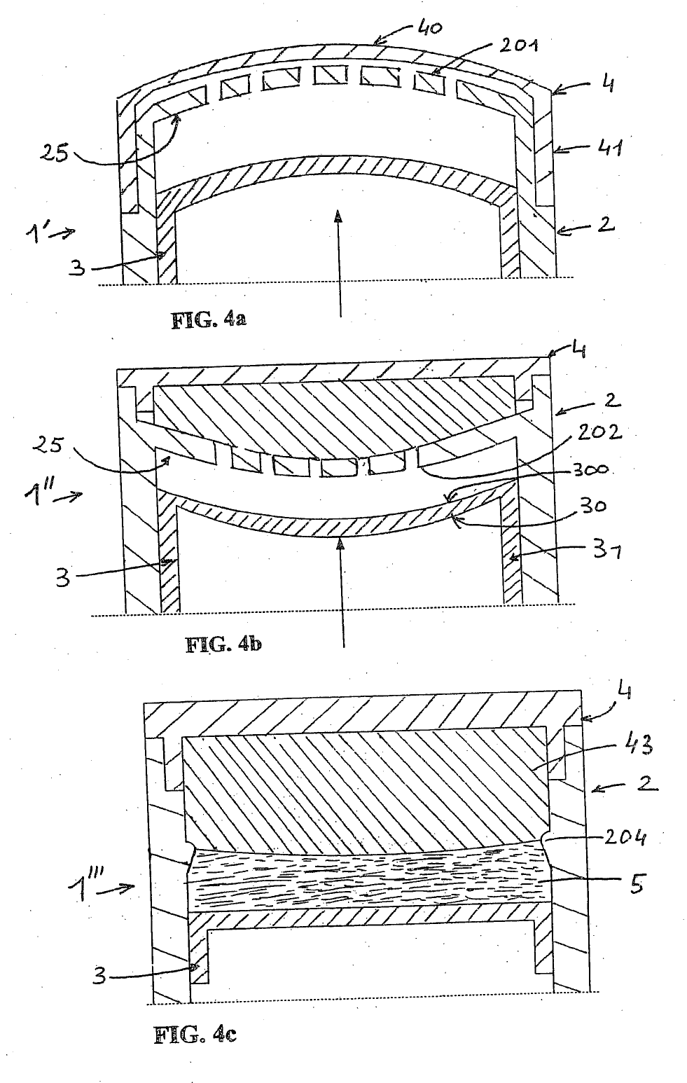

In particular, in the case where the dispenser 1″ includes a dished arch 20, in particular with a dished grate 202, as shown in FIG. 4b, said cap 4 may include a means of application 43 of said product 5. This means of application may consist of a textile-based material and form the equivalent of a puff.

More preferably, and as shown in FIGS. 1a, 4a and 4b, said piston 3 may include a head 30 whose top surface 300 is parallel to said arch 20 or to the bottom surface 25 of said arch 20, so as to be able to expel nearly all of said product 5 contained inside said body 2 or said chamber 9, when said piston 3 is at its end of travel position.

Typically, and as shown in FIGS. 1a, 4 a and 4b; said piston 3 may include a lower skirt 31 which, together with said head 30, typically forms a blind hole 32, so as to facilitate the sliding of said piston 3 inside of said skirt 21 of said body, and so as to enable the insertion of said finger ensuring said thrust into said blind hole. Typically, this lower skirt may have a height of a few mm.

According to the invention, said cap 4 may typically include a head 40 and a skirt 41 cooperating reversibly with said tubular body 2, said skirt 41 having a height typically ranging from h/2 to h, in particular when the cap or its skirt 41 is fit on over a bored upper portion 27 of said body 2, as shown, for example, in FIG. 1a.

As also shown in FIG. 1a, said skirt 41 of the cap 4 may have the same exterior cross section as that of said tubular body 2 or of said skirt 21 of said tubular body 2, so as to have a dispenser 1, 1′, 1″ that, when closed, has the same cross section over its entire height H.

In order to have a typically leak-proof dispenser, it may be advantageous that said head 40 include a means 400 for reversibly sealing said opening 22, 220, 221, 222, typically a circular or peripheral rib coming to rest against or surrounding said axial projection 26, as shown in FIG. 1a. In this case, besides the cooperation of the skirt 41 with the upper bored portion 27 of the body 2, the cap 4 includes a complementary means of ensuring the tightness of the dispenser in the case where said product includes at least one volatile component.

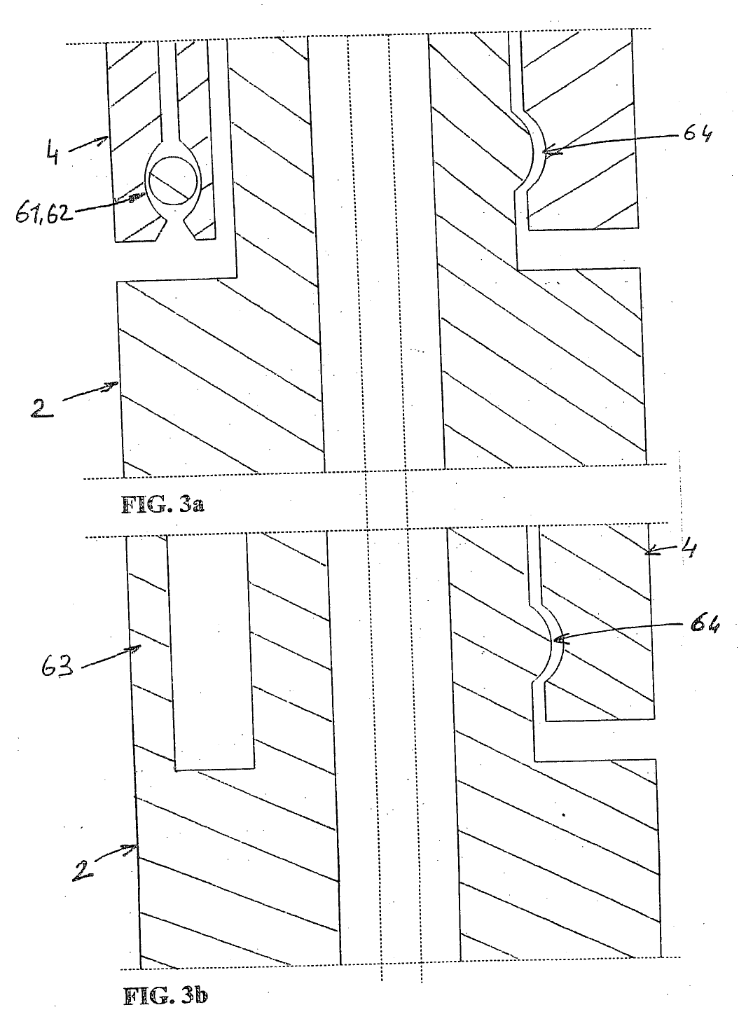

The cap may cooperate with said body in many different ways. Thus, said cap 4 may cooperate with said body 2 at its upper portion or with said arch 20, so as to form a reversible means of cooperation 6, typically by screwing, by snapping on 61 via the cooperation of a male element and a female element, by fitting on 60, or by means of a hinge 62. Cooperation by means of fitting on or snapping on has been shown in FIG. 1a. In this case, the upper bored portion 27 may include a rib 270 that may cooperate with a groove 410 formed on the inside surface of the skirt 41 of the cap 4. A hinge-type or snap-on type cooperation has been shown in FIG. 3a. In addition, as shown in FIG. 3b, said cap 4 may be made integral with said body by means of a tab 63, so as to form a single piece.

According to the invention, said tubular body 2, and/or said piston 3, and/or said cap 4 may be made of a plastic material, typically molded, said plastic material possibly consisting of a transparent plastic material. Advantageously, all of the parts forming said dispenser 1, 1′, 1″ are molded parts made of a thermoplastic material, typically polyolefin, and most often PP.

When closed, said dispenser according to the invention may typically have a height H and a largest dimension D such that H/D ranges between 0.80 and 1.4, so as to form a compact dispenser.

According to one embodiment of the invention shown in FIG. 6, said cap 4 may have an upper profile 42 capable of cooperating reversibly with said lower portion 23 of said skirt 21 of said tubular body 2, typically by snapping on axially, so as to be able to stack several dispensers 1, 1′, 1″ and form a stick or set 7 of dispensers 1, 1′, 1″ made integral with each other temporarily, said lower portion 23 of said skirt 21 of a first dispenser cooperating axially with said cap 4, or said upper portion 24 of said skirt 21 of a second dispenser placed underneath the first.

As shown in FIG. 4c, the invention may include dispensers 1′″ whose arch 20 is limited to a contracted section of said skirt 21 formed by a circular rib 204 having a height ranging typically from 0.5 to 2 mm, such dispensers being used to package solid products capable of deforming under stress, e.g., powders for blocks of compressed powder for makeup.

Another object of the invention consists of a set of dispensers 7, 8 typically grouping together several dispensers 1, 1′, 1″, 1′″ according to the invention, these dispensers possibly differing by the nature and/or the color of the makeup products 5, or by the nature or degree of fineness of said means of application. As a matter of fact, owing in particular to the compactness and relatively low cost of said dispenser 1, 1′, 1″, 1′″, the invention has made it possible to develop sets of dispensers 7, 8 that actually solve numerous problems encountered by the users, i.e., arranging various cosmetic products or various means of application even inside one handbag. However, as concerns the use of handbags, besides searching for keys, another well-known problem lies in the classic search for makeup products. In this respect, the sets 7, 8 according to the invention solve these two problems simultaneously.

According to a first embodiment, and as shown in FIG. 6, said set may be a set 7 formed by rendering one dispenser integral with another dispenser, so as to obtain a stack of N dispensers 1, 1′, 1″, 1′″ including said upper profile 42, so as to thereby obtain a so-called “vertical” makeup set 7. According to this embodiment, it may be advantageous for said upper profile 42 to be selected such that, when said first dispenser is separated from said second dispenser, or more generally when a dispenser of row n is separated from a dispenser of row n+1 situated above the dispenser of row n in said stick 7, this separation does not result in the separation of the cap 4 from the dispenser of row n, with the result being that the piston 3 of the dispenser n+1 is accessible.

According to a second embodiment, and as shown in FIGS. 5a to 5d, said set may be a set of N dispensers 1, 1′, 1″, 1′″ made reversibly integral with each other on a typically plane common support 80, 81, 82, each of said dispensers being accessible separately from the others so as to form a so-called “horizontal” or “plane” makeup set 8. Various variants of this embodiment have been shown in FIGS. 5b to 5d.

Irrespective of the embodiment chosen, the number N of dispensers 1, 1′, 1″, 1′″ can typically range from 2 to 20, and more preferably from 4 to 10. It is possible to have sets of varying sizes with, for example, a large size set comprising 20 dispensers or more, that would be typically non-transportable and intended for bathroom use, and a small size set with, for example, 2 to 6 dispensers intended to be transported in a handbag, the selection of dispensers to be carried along possibly varying each day.

Another object of the invention consists of the use of said dispenser 1, 1′, 1″, 1′″ or said set of dispensers 7, 8 for sampling or promoting said product 5, or for the commercial distribution of said product 5. For this use, said product may be selected from among the cosmetic or dermatological products applied to the skin or face, and typically:

a) a paste-like product of the lipstick or makeup pencil type,

b) a product in the form of a cream, gel or paste,

c) a product in the form of a powder,

said product having a viscosity suited, in particular, to the surface area S′ of said opening or of said openings, or else said surface area S′ being suited to the viscosity of said product such that said, piston is able to slide while expelling said product through said opening under the effects of an axial force ranging typically from 0.2 N to 2 N. As a matter of fact, the invention is not limited to cosmetic products alone, it also applies to any care product for the skin, face and lips in particular, whether it involves dermatological products or skin-protective products of the sun cream type.

### Exemplary Embodiments

All of the figures consist of exemplary embodiments. All of the dispensers 1, 1′, 1″, 1′″ were made of PP or PE, by means of molding. More specifically, the dimensions H and d were use in FIGS. 1a and 1b.

Very many dispensers have been manufactured by varying in particular the dimensions of the openings. Thus, on the one hand, with a plurality of small-diameter openings 222, typically ranging from 0.4 to 1 mm, it was possible to package liquid products that did not have a tendency to flow out, even when holding the dispenser upside down. On the other hand, with a dispenser similar to the one shown in FIG. 4c, it was possible to package a solid product with relatively high cohesiveness such as a compact powder generally packaged in boxes, the residual plasticity of the compact powder being sufficient, however, to enable a certain degree of creep or a certain degree of deformation under manual stress. In this case, the ratio S′/S was close to 0.95, the arch 20 forming an edge 204 that was sufficiently constricted in relation to the skirt 21 of the body 2 so that said solid product was retained inside said chamber, but not too constricted, however, for manual pressure applied to the piston to be able to advance said product as it was being used. In the case of this solid product, a cap 4 with a built-in applicator was used.

Sets have also been manufactured of the type like set 8, diagrammed in FIGS. 5a to 5d, but in which some dispensers 1 were replaced by complementary means of application, as if, with an arrangement such as the one shown in FIG. 5b, the body of the dispenser had been replaced in some cases by a complementary means of application.

Generally speaking, in the case of the dispensers manufactured, and in view of their relatively small dimensions, the frictional forces between piston 3 and skirt 21 are sufficient for the piston to maintain the position in which it is situated, with the result being that it was not necessary to equip the inside of the skirt 21 with non-return means so that the piston is able to move upward only. However, these frictional forces in no way prevent the piston from being pushed forward manually. Thus, in the case of a dispenser 1 according to FIG. 1a, the weight of the product contained inside the chamber does not carry the piston downward, even when-the cap is removed. The case would not be the same with similar but larger size dispensers.

In addition, as shown in FIG. 1a, the head 30 and the skirt 31 of the piston 3 generally connect together along an arc, both in order to facilitate the insertion of the piston into the skirt and to match the interior profile of the connection between the skirt 21 and the arch 20 or that which serves as an arch.

### Advantages of the Invention

This invention has numerous advantages. On the one hand, it discloses dispensers that can be customized to the packaging of all sorts of products, typically by selecting an adequate opening diameter. On the other hand, it solves the problems of bulkiness associated with the diversity of products, in particular makeup or skin care or lip care products, while traveling or moving. In addition, it offers new, economical and sturdy dispensers, as well as new sets of dispensers that meet the requirements of the users, while at the same time significantly renewing the product supply for the cosmetic or skin care products market.

| List of Reference Marks | |
|---|---|
| Dispenser | 1, 1′, 1″, 1′′′ |
| Vertical axis | 10 |
| Tubular body | 2 |
| Arch | 20 |
| Plane grate | 200 |
| Domed grate | 201 |
| Dished grate | 202 |
| Radial extension | 203 |
| Circular edge or rib | 204 |
| Skirt | 21 |
| Opening | 22 |
| Circular opening | 220 |
| Lip | 2200 |
| Opening - radial slot | 221 |
| Lips | 2210 |
| Multiple openings | 222 |
| Lower portion of 21 | 23 |
| Upper portion of 21 | 24 |
| Bottom surface of 20 | 25 |
| Axial projection | 26 |
| comprising 22, 222 | |
| Upper bored portion | 27 |
| cooperating with 31 | |
| Rib cooperating with 410 | 270 |
| Means of application | 28 |
| Piston | 3 |
| Head | 30 |
| Upper surface | 300 |
| Skirt | 31 |
| Blind hole | 32 |
| Cap | 4 |
| Head | 40 |
| Means for plugging 22 | 400 |
| Skirt | 41 |
| Groove cooperating with 270 | 410 |
| Upper profile | 42 |
| Means of application | 43 |
| Product | 5 |
| Means of cooperation between 2 and 4 | 6 |
| Fitting on | 60 |
| Snapping on | 61 |
| Hinge | 62 |
| Common tab | 63 |
| Means of fastening 4 | 64 |
| “Vertical” or stick-like makeup set | 7 |
| “Plane” makeup set | 8, 8′ |
| Support of 1 with movable 1 | 80 |
| Positively connecting | 800 |
| cavities | |
| Support of 1 with 4 fixed to 8 | 81 |
| Means of assembling 4 onto 81 | 810 |
| Support of 1 forming 4 | 82 |
| Cap-forming walls | 820 |
| Support of 8′ | |
| Open cavity for 3 | 830 |
| Cavity with bottom for 43. | 831 |
| Chamber formed by 20 + 21 + 3 | 9 |

1. Dispenser (1. 1′, 1″) of a product (5), typically a paste-like cosmetic product, comprising:
a) a tubular body (2) containing said product (5) and comprising a skirt (21) open at its lower part and closed at its upper part by an arch (20) equipped with an opening (22), or possibly with multiple openings (222), having a total surface area S′ enabling the passage of said product (5) with a view to its use or application onto a support,
b) a piston (3) capable of sliding, in a typically leak-proof manner, inside of said skirt (21), over a stroke height h, so as to form a variable-volume chamber (9) containing said product and to compress said product with a view to forcing the passage of said product (5) through said opening (22, 222),
c) a cap (4) designed to seal said opening (22, 222), typically comprising a head (40) and a skirt (41) cooperating reversibly with said tubular body (2) at its upper part or with said arch (20), characterized in that:
1) said skirt (21) and said arch (20) form a single piece, typically a molded piece made of plastic,
2) said piston (3) includes a lower skirt (31) typically forming, together with said head (30), a blind hole (32), so as to facilitate the sliding of said piston (3) inside said skirt (21) of said body, and to enable the insertion of said finger ensuring said push into said blind hole,
3) said head (40) includes a means (400) for reversibly sealing said opening (22, 220, 221, 222),
4) said skirt (21) has an interior horizontal section with a surface area S and with a smaller interior dimension d ranging typically from 10 mm to 20 mm, said stroke height h ranging typically from 10 to 25 mm, so as to simultaneously, and typically with a single hand, enable said dispenser (1, 1′, 1″) to be grasped manually, typically between the thumb and middle finger, and said piston (3) to be pushed manually using one finger, typically the index finger, so as to force, in a typically controlled manner, said passage of said product through said opening (22, 222) having a surface area S′≦0.95.S, typically selected with respect to the nature and the viscosity of said product (5), said dispenser (1, 1′, 1″) being an extension of said finger and thereby forming a so-called “fingertip” dispenser that is at once economical, compact and versatile.

2. Dispenser as claimed in claim 1, in which said skirt (21) of said body (2) has a round, oval or square interior and/or exterior cross section, said interior cross section corresponding to that of said piston (3) and having a surface area S ranging typically from 50 mm² to 400 mm², and more preferably from 150 to 250 mm².

3. Dispenser as claimed in claim 1, in which said arch (20) includes or forms at least one radial extension (203) partially sealing said surface area S, so that the surface area S′ of said opening (22, 222) typically ranges between 0.2.S and 0.8.S, said surface area being chosen, in particular, with respect to the viscosity of said product, and so as to typically form multiple openings.

4. Dispenser as claimed in claim 1, in which said arch (20) include or forms a grate, typically plane (200), but potentially domed (201), or dished (202), equipped with a large number of openings, said number typically ranging from 5 to 50, and having a surface area S′<0.7.S.

5. Dispenser as claimed in claim 1, in which said opening (22) is a radial slot (221) having a length typically close to d, and a surface area S′<0.5.S.

6. Dispenser as claimed in claim 5, in which said radial slot (221) forms potentially flexible lips (2210), being typically parallel, and typically angled so as to form an applicator for said product over a width d′.

7. Dispenser as claimed in claim 1, in which said opening 22 is a circular opening (220) having a diameter typically less than 5 mm, and a surface area S′<0.3.S, and typically forming a circular lip (2200) so as to ensure a localized or spot application of said product (5).

8. Dispenser as claimed in claim 1, in which said arch (20), equipped with said opening (22, 220, 221, 222), forms a means of application of said product.

9. Dispenser as claimed in claim 1, in which said cap (4) includes a means of application (43) of said product (5).

10. Dispenser as claimed in claim 1, in which said piston (3) includes a head (30) whose top surface is parallel to said arch (20) or to the interior surface (25) of said arch (20), so as to be capable of expelling almost all of said product (5) contained inside said body (2), or said chamber (9), when said piston (3) is at its end of travel position.

11. Dispenser as claimed in claim 1, in which said cap (4) includes said head (40) and said skirt (41), said skirt (41) having a height typically ranging from h/2 to h.

12. Dispenser as claimed in claim 11, in which said skirt (41) has the same exterior cross section as that of said tubular body (2) or of said skirt (21) of said tubular body (2), so as to have a dispenser (1, 1′, 1″) that, when closed, has the same cross section over its entire height H.

13. Dispenser as claimed in claim 1, in which said cap 4 cooperates with said body (2) at its upper portion or with said arch (20), typically by screwing on, by snapping on (61) via cooperation of a male element and a female element, by fitting on (60), by means of a hinge (62), so as to form a reversible means of cooperation (6).

14. Dispenser as claimed in claim 1, in which said cap (4) is made integral with said body by means of a tab (63), so as to form a single piece.

15. Dispenser as claimed in claim 1, in which said tubular body (2), and/or said piston (3), and/or said cap (4) is/are made of a plastic material, typically molded, that may potentially be a transparent plastic material.

16. Dispenser as claimed in claim 1 that, when closed, has a height H and a larger dimension D such that H/D ranges between 0.80 and 1.4.

17. Dispenser as claimed in claim 1, in which said arch (20) is a constricted portion of said skirt (21) formed by a circular rib (204) having a height typically ranging from 0.5 to 2 mm, so as to package solid products capable of deforming under stress, typically powders for blocks of compressed powder for makeup.

18. Dispenser as claimed in claim 1, in which said cap (4) has an upper profile (42) capable of cooperating reversibly with said lower portion (23) of said skirt (21) of said tubular body (2), typically by snapping on axially, so as to be able to stack several dispensers (1, 1′, 1″) and to form a stick or set (7) of dispensers (1, 1′, 1″) made temporarily integral with each other, said lower portion (23) of said skirt (21) of a first dispenser cooperating axially with said cap (4), or said upper portion (24) of said skirt (21), of a second dispenser placed underneath the first.

19. Set of dispensers as claimed in claim 1, typically grouping together several dispensers (1, 1′, 1″) possibly differing by the nature and/or the color of the makeup products (5), or by the nature or degree of fineness of said means of application.

20. Set as claimed in claim 19, formed by making one dispenser integral with another dispenser, so as to obtain a stack of N dispensers (1, 1′, 1″) comprising said upper profile (42), so as to thereby obtain a so-called “vertical” makeup set (7).

21. Set as claimed in claim 20, in which said upper profile (42) is selected such that, when said first dispenser is separated from said second dispenser, or more generally speaking, when a dispenser of row n is separated from a dispenser of row n+1 situated above the dispenser of row n in said stick (7), this separation does not result in the separation of the cap (4) from the dispenser of row n, with the result being that the piston (3) of the dispenser n+1 is accessible.

22. Set as claimed in claim 20, formed by making N dispensers (1, 1′, 1″) reversibly integral with each other on a typically plane common support (80, 81, 82), each of said dispensers being accessible separately from the others so as to form a so-called “horizontal” or “plane” makeup set (8).

23. Set as claimed in claim 20, in which N typically ranges from 2 to 20, and more preferably from 4 to 10.

24. Use of said dispenser (1, 1′, 1″) as claimed in claim 1, or of said set of dispensers (7, 8), as claimed in any of claims 19 to 23, for the sampling or the promotion of said product (5), or for the commercial distribution of said product (5).

25. Use as claimed in claim 24, in which said product is selected from among the cosmetic or dermatological products applied to the skin or face, and typically:
d) a paste-like product of the lipstick or makeup pencil type,
e) a product in the form of a cream, gel or paste,
f) a product in the form of a powder,
said product having a viscosity suited, in particular, to the surface area S′ of said opening or said openings, or else said surface area S′ being suited to the viscosity of said product, so that said piston is able to slide while expelling said product through said opening under the effects of an axial force ranging typically from 0.2 N to 2 N.
